(19) United States
(12) Patent Application Publication
(10) Pub. No.: US 2007/0259723 A1
(43) Pub. Date: Nov. 8, 2007

(54) Multidirectional Transmission

(76) Inventor: Romolo Lorenzo Bertani, New South Wales (AU)

Correspondence Address: PERKINS COIE LLP, P.O. BOX 2168, MENLO PARK, CA, 94026, US

(21) Appl. No.: 10/586,266

(22) PCT Filed: Jan. 24, 2005
(86) PCT No.: PCT/AU05/00075

§ 371 Date: May 21, 2007

(30) Foreign Application Priority Data
Jan. 23, 2004 (AU) 2004900326

(51) Int. Cl. B23Q 5/04

(52) U.S. Cl. 464/134

(57) ABSTRACT

A transmission (300) for a hand-tool comprising a drive shaft (325) having a first axis of rotation, a driven shaft (322) having a second axis of rotation and being rotationally coupled to said drive shaft via at least one universal joint (326, 328). A housing (314) is adapted to receive said drive shaft and said driven shaft and is further adapted to allow the axis of rotation of the driven shaft to be adjustably varied relative to the axis of rotation of the give shaft.

### FIELD OF THE INVENTION

The present invention relates to multidirectional transmission for a hand-tool.

### BACKGROUND OF THE INVENTION

Hand-tools, and in particular handheld drills are known which have transmissions that can drive a rotating tool about an axis aligned at an angle relative to the drive motor of the hand-tool. U.S. Pat. No. 5,020,281 discloses a rotary hand-tool with an angularly adjustable head. The hand-tool has a transmission including a flexible drive cable that provides rotational drive from the tool's motor to the head. The tool's head includes a geared mechanism which drives the tool about an axis of rotation set perpendicularly to the axis of rotation of the incoming drive cable. Moreover the angle of the head can be changed in use to allow a user to select the angle of the rotation axis of the tool.

International patent application PCT/IB97/01347 (published as International publication no. WO 99/21686) also describes a multidirectional transmission which uses a flexible drive cable to transmit power from the drive motor to the tool.

The present inventor has found that multidirectional or angular transmissions having a flexible drive cable of the type including at least one axially extending core strand surrounded by one or more of helically wound strand wrapped around the core, have a number of disadvantages.

A disadvantage associated with such transmissions is that the drive cord is prone to breakage either with extended use, or through the application of excessive torque to the tool. It has also been found that using a cord drive allows excessive backlash or “play” in tool bit due to the deformation of the cord when torque is applied to it. It has further been found that using a flexible cord drive is disadvantageous in applications, such as when used in conjunction with devices including and electric screwdrivers and reversible power drills in which the direction of the rotation can be changed from clockwise to anticlockwise as breakage of the drive cord may occur due to the effective unwinding of the outer layers of the drive cord. Furthermore, numerous alternations in direction of rotation for such cord drives decreases the fatigue life of the cord thus resulting in premature failure. Other disadvantages of such transmissions include deficiencies experienced in direct-drive application such as tightening or loosening of fasteners, nuts, bolts and the like.

The present inventor has also discovered that the abovementioned problems increase with increasing length of the drive cord, thus substantially limiting the maximum length of a transmission driven by a flexible cable.

One solution to overcome the disadvantages of transmissions using flexible drive cables is to use a transmission having plurality of bevel gears which are arranged so as to offset the rotation axis of the drive shaft from the rotation axis of the driven shaft. However such devices are also prone to failure, typically due to the teeth shearing off the gears, under high load.

Any discussion of documents, publications, acts, devices, substances, articles, materials or the like which is included in the present specification has been done so for the sole purpose so as to provide a contextual basis for the present invention. Any such discussions are not to be understood as admission of subject matter which forms the prior art base portion, or any part of the common general knowledge of the relevant technical field in relation to the technical field of the present invention to which it extended at the priority date or dates of the present invention.

### SUMMARY OF THE INVENTION

In a first aspect, the present invention provides a multidirectional transmission for a rotary hand-tool comprising:

a drive shaft having a first axis of rotation;

a driven shaft having a second axis of rotation and being rotationally coupled to said drive shaft via at least one universal joint; and

a housing adapted to receive said drive shaft and said driven shaft, and being adapted to allow the axis of rotation of the driven shaft to be adjustably varied relative to the axis of rotation of the drive shaft.

In a second aspect, the present invention provides a multidirectional transmission for a rotary hand-tool comprising:

a driven shaft having a first axis of rotation, said driven shaft being rotationally engageable with a drive shaft having a second axis of rotation via at least one universal joint; and

a housing adapted to receive a drive shaft and said driven shaft, and being adapted to allow the axis of rotation of the driven shaft to be adjustably varied relative to the axis of rotation of the drive shaft.

In an embodiment of the first and second aspects, the housing preferably includes an input end adapted to receive said drive shaft and an output end adapted to receive said driven shaft, and said housing is articulated to allow said axis of rotation of the drive shaft to be adjustably varied relative to the axis of rotation of the driven shaft.

Preferably the drive shaft is adapted to be detachably rotationally coupled to an output shaft of a rotary hand-tool.

In a third aspect, the present invention provides rotary hand-tool having a multidirectional transmission including:

a driven shaft having a first axis of rotation, said driven shaft being rotationally engaged via at least one universal joint with the drive shaft of the hand-tool having a second axis of rotation; and

a housing adapted to receive said drive shaft and said driven shaft, and being adapted to allow the axis of rotation of the driven shaft to be adjustably varied relative to the axis of rotation of the drive shaft.

In an embodiment of the above aspects, the driven shaft and the drive shaft are preferably coupled with the housing to allow vibrational axial translation of said driven shaft and said drive shaft in relation to said housing.

Preferably, the multidirectional transmission further comprising one or more intermediate shafts coupled between said drive shaft and said driven shaft. Preferably each intermediate shaft is coupled to an adjacent shaft via a universal joint.

Preferably, the housing includes at least two substantially cylindrical housing elements arranged end to end, said housing elements having a passage formed therethrough lying substantially along a longitudinal axis of the housing and being adapted to receive the transmission shafts. The housing elements preferably further include a seating surface lying in a plane inclined at oblique angle to the longitudinal axis of the housing element, wherein the relative orientation of adjacent housings elements is adjustable by rotation of the adjacent housing elements about the normal axis to said seating surface. Preferably the seating surface is adapted to abut a corresponding seating surface of an adjacent housing element.

Preferably the driven shaft and the drive shaft are articulated with respect to each other such that the pivot axis of said at least one universal joint is located in the plane of said seating surface. More preferably, the planes in which the seating surfaces of adjacent housing elements lie form a supplementary angle with each other such that in a first relative orientation the housing elements are coaxial with respect to the longitudinal axes of housing elements. Preferably, the housing comprises at least three housing elements.

The housing preferably includes a locking means adapted fix one housing element relative to an adjacent housing element to allow the axis of rotation of said drive shaft to be fixed relative to the axis of rotation of said driven shaft at a selected orientation. Preferably the locking means includes a locking nut threadingly engageable with a first housing element and rotationally slidingly engaged in relation to an adjacent housing element, wherein upon rotation of said locking nut, the first housing element and the adjacent housing elements are urged toward each other such that the housing elements are fixed relative to each other.

The locking means preferably further includes a retainer member for retaining said locking nut in relation to said adjacent housing element, said locking nut being rotationally slidingly engaged with said retainer member, wherein upon rotation of said locking nut said locking nut is advanced toward said first housing element, and said retainer member is urged toward and abutted with said first housing element by said locking nut such that the housing elements are fixed relative to each other. More preferably the locking nut is engaged with said first housing element and said retainer member, and said retainer member is non-detachably engaged with said adjacent housing element in a manner such that upon release of said locking means by rotation of said locking nut, the housing elements are detained in a coupled relationship.

Preferably the multidirectional transmission further comprising at least one housing extension element detachably engageable with said housing, said housing extension element allowing use of an extended drive shaft and/or use of an extended driven shaft.

The housing may include an illumination means for providing light to a work area adjacent the transmission and may further include a coolant delivery means for delivering coolant to a work area adjacent the transmission.

Preferably said drive shaft, said driven shaft, said at least one universal joint and said housing are integrally formed.

In an embodiment of the above aspects, the hand-tool is preferably driven by electrical, pneumatic, hydraulic or manual means, and is adapted to drive a rotationally driveable device including a screw, a bolt, a nut, a fastener, a stud or a drill bit. The rotary hand-tool preferably includes a bi-directional drive device. Preferably the transmission includes an engagement means for engagement with a tool bit.

In an embodiment of the third aspect, the housing is preferably formed integrally with the rotary hand-tool. Preferably the rotary hand-tool includes an axial vibrational drive.

Throughout the specification the term “comprise” and variations on this term including “comprising” and “comprises” are to be understood to imply the inclusion of a feature, integer, step or element, and not exclude other features, integers, steps or elements.

These and other advantages of the present invention will become apparent reading the following description.

### BRIEF DESCRIPTION OF THE DRAWINGS

Preferred embodiments of the present invention will now be described by way of non-limiting example only with reference to the accompanying drawings in which:

FIG. 1a shows a schematic cut away view of a multidirectional transmission according to a first embodiment of the present invention;

FIG. 1b shows the multidirectional transmission of FIG. 1a in a first angular orientation;

FIG. 1c shows the multidirectional transmission of FIGS. 1a and 1b in a second angular orientation;

FIG. 2 shows a multidirectional transmission according to an embodiment of the present invention mounted on a hand-drill;

FIG. 2a shows the transmission of FIG. 2 at a first selected orientation;

FIG. 2b shows the transmission of FIG. 2 and FIG. 2a at a second selected angular orientation;

FIG. 2c shows the transmission of FIGS. 2, 2a and 2b at another selected angular orientation;

FIG. 3 shows a top view of the transmission of FIGS. 2, 2a, 2b and 2c at yet another angular orientation;

FIG. 4 shows a perspective view of a clamping collar used in an embodiment of the present invention;

FIG. 5a shows a cross sectional view of a multidirectional transmission according to a second embodiment of the present invention in a linear orientation;

FIG. 5b shows the multidirectional transmission of FIG. 5a at a first angular orientation;

FIG. 5c shows and enlarged view of FIG. 5b;

FIG. 5d shows an enlarged spot-sectional view of FIG. 5c;

FIG. 6a shows a further embodiment of a distal housing element of FIGS. 5a to 5d;

FIG. 6b shows a side view of a clamping collar forming part of the multidirectional transmission of FIGS. 5a to 5d;

FIG. 6c shows a sectional assembly view of the transmission of FIG. 5a and the clamping collar of FIG. 6b;

FIG. 7a shows a sectional view of an extension member; and

FIG. 7b be shows a sectional assembly view of the clamping collar of FIG. 6b, the extension member of FIG. 7a, the transmission of FIG. 5b and an adapter member.

### DETAILED DESCRIPTION OF THE EMBODIMENTS

Embodiments of the present invention will now be described with reference to an example of a rotary hand-tool transmission fitted to a powered hand-drill, however the present invention should not be considered to be limited to use in this application but should be considered to be applicable to hand-tools in general of the type in which rotational motion is transmitted from a drive shaft to a driven shaft. For example a transmission of the present invention could be used in connection with an angle grinder, a router, a powered screwdriver, a pneumatic drive, or the like.

To facilitate an understanding of the invention, reference is made in the description to the accompanying drawings whereby the rotary hand-tool transmission is illustrated in preferred embodiments. Similar components between the embodiments are identified by the same reference numerals.

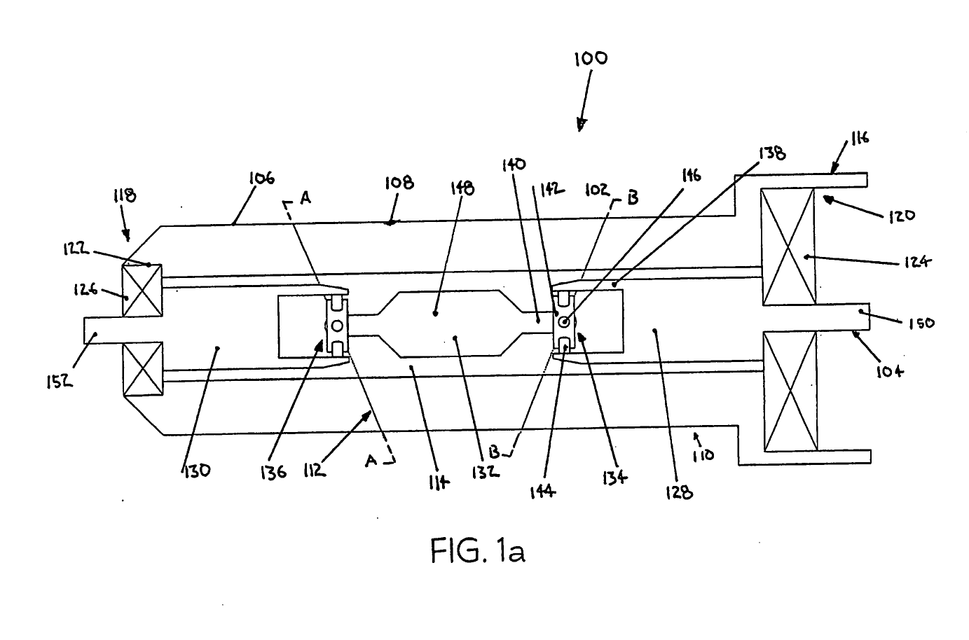

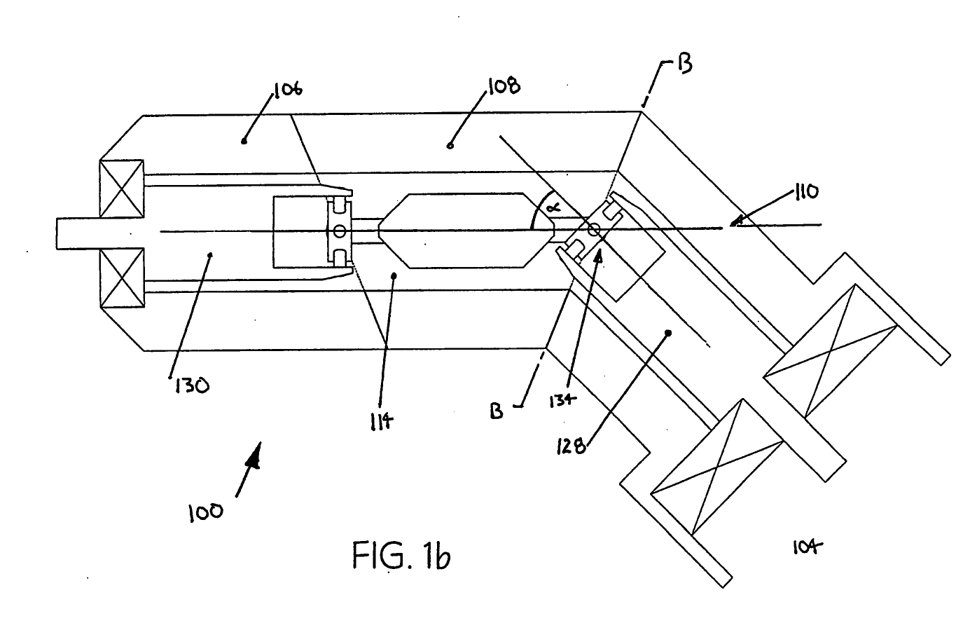

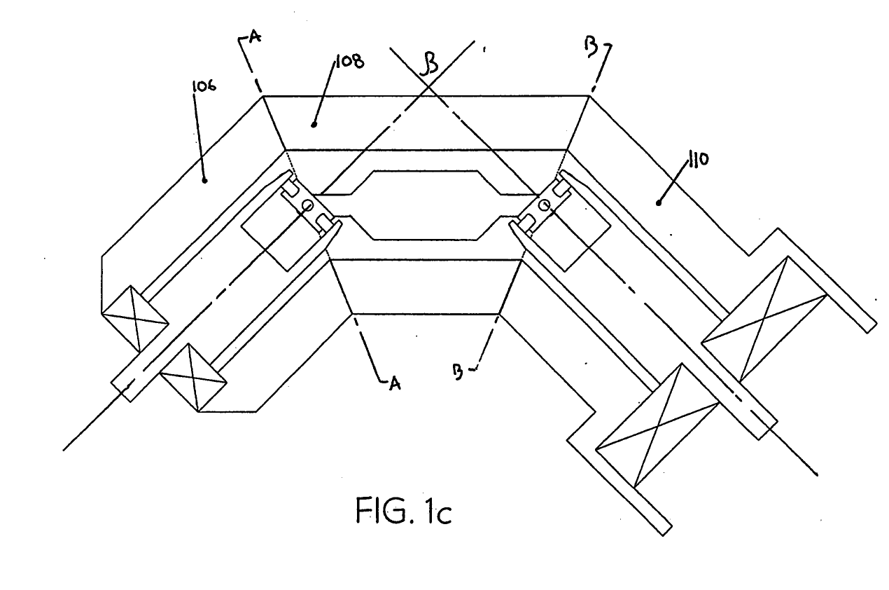

FIG. 1a shows the cutaway side view of a multidirectional transmission configured to be fitted to a powered hand-drill. The transmission 100 includes housing 102 and a transmission shaft assembly 104 mounted within the housing 102. The housing is articulated to allow the angle of the driven shaft (relative to the drive shaft) of the transmission to be selected by the user.

The housing 102 is comprised of three housing elements 106, 108 and 110, which in the orientation shown in FIG. 1a are arranged co-axially. The pairs of neighbouring housing elements, eg 106 and 108, and 108 and 110 abut along planes A-A and B-B respectively. Each of the housing elements 106, 108 and 110 have seating surfaces, for example, surface 112 of housing element 116, which are configured to abut against the corresponding seating surface of neighbouring housing element. The housing 102 further includes a passageway 114 extending throughout its length which is configured to receive the transmission assembly 104 of the transmission 100. The transmission housing 102 has a mounting attachment 116 at is proximal end. The mounting attachment in the present embodiment is formed integrally with the housing element 110 and is configured to be clamped onto a portion of the body of a hand-tool to which the transmission 100 is fitted. In the present embodiment the mounting attachment takes the form of a collar that can be clamped on to an annular flange of the hand-tool's casing in use to hold the transmission in use.

The proximal end 116 and distal end 118 of the housing each have a stepped internal bores 120 and 122 respectively which are configured to receive journal bearing assemblies 124 and 126 respectively for holding the transmission assembly 104.

In the present embodiment, the transmission shaft assembly 104 includes three main shafts, namely a drive shaft 128, which is mounted at the proximal end of the housing 102, a driven shaft 130, which is mounted at the distal end 118 of the housing and an intermediate shaft 132 that is coupled between the drive shaft 128 and the driven shaft 130. The drive shaft 128 and the driven shaft 130 are coupled to the intermediate shaft 132 via universal joints 134 and 136 respectively. As will be seen, the universal joints 134 and 136 allow the relative angle formed between the drive shaft 128 and the driven shaft 130 to be varied.

In the present embodiment the universal joints 134 and 136 are of a known type typically referred to as a “Hooke's Joint” or “Cardan Joint”. As will be appreciated by those skilled in the art other types of universal joints may also be employed in embodiments of the present invention without departing from the scope of the invention. Referring to joint 134, the universal joints 134 and 136 include a pair of orthogonally oriented yokes 138 and 140 which are connected to a central cube or spider 142, by pivot pins, eg 144 and 146 respectively. The intermediate transmission shaft 132 includes a central portion 148 which terminates at either end in the arms of the yoke of the universal joint, e.g. 140.

It should be noted that in present embodiment the effective pivot points of the universal joints 134 and 136 lie in same plane as the abutting seating surfaces of the housing elements 106, 108 and 110, that is, the pivot points of the universal joints lie in planes A-A and B-B. Thus in use when the housing element rotated about their seating surfaces in either plane A-A or plane B-B the transmission shaft assembly also pivots in that plane, and accordingly the drive shaft assembly remains able to rotate effectively about the axis of each housing element 106, 108 and 110. Such an arrangement minimises the bore size of the central passageway through the housing segments.

In use the transmission 100 is configured to be mounted to the body of a hand-tool, in this instance preferably a powered hand-drill, or cordless drill. The proximal end 150 of the drive shaft 128 is configured to be coupled to the driveshaft of the hand-drill in order to connect the transmission shaft assembly 104 to the drive motor of the hand-drill. The distal end 152 of the driven shaft is configured to be coupled to a drill chuck or other tool holder or the like. The means for coupling of the transmission shaft assembly 104 to both the driveshaft/motor of the hand-tool, and the drill chuck, can take a variety of forms, as will be appreciated by those skilled in the art and accordingly, the coupling means is not described here in detail.

Various means for maintaining or locking the relative orientation of the housing elements can be used with embodiments of the present invention, including means using a biased detent (e.g. ball) mounted to one of the housing elements that locks into a recess in an abutting housing element, or one or more releasable locking keys. Examples of suitable locking means are described in detail in PCT/IB97/01347 (publication no WO 99/21686) in particular in connection with FIGS. 1a, to 1c, 2, 2a, 2B and 3, the contents of which are herein incorporated by reference.

FIG. 1b shows the transmission 100 of FIG. 1a in a configuration in which the driven shaft 130 lies at an angle α(45) with respect to drive shaft 128. In order to put the transmission 100 into this configuration, the forward most two housing elements 106 and 108 are rotated 180 degrees about plane B-B. Due to the angle that plane B-B forms with the axis of the drive shaft, rotation of the front most housing segments 106 and 108 about plane B-B offsets the axis of the driven shaft with respect to the drive shaft by 45 degrees.

Notwithstanding the reconfiguration of the housing it can be seen that the pivot point of the universal joint 134 remain in plane B-B, and thus the transmission's shafts continue to lie coaxially within their respective housing elements.

As will be appreciated by those skilled in the art a further angular offset of the driven shaft 130 from the drive shaft 128 can be achieved by re-orienting the front most housing element 106 with respect to the intermediate housing element 108. This configuration is shown in FIG. 1c. In FIG. 1c the front most housing element 106 has been rotated about plane A-A. This results in an off-set angle between the driven shaft 130 and the drive shaft 128 of β which is equal to 90 degrees.

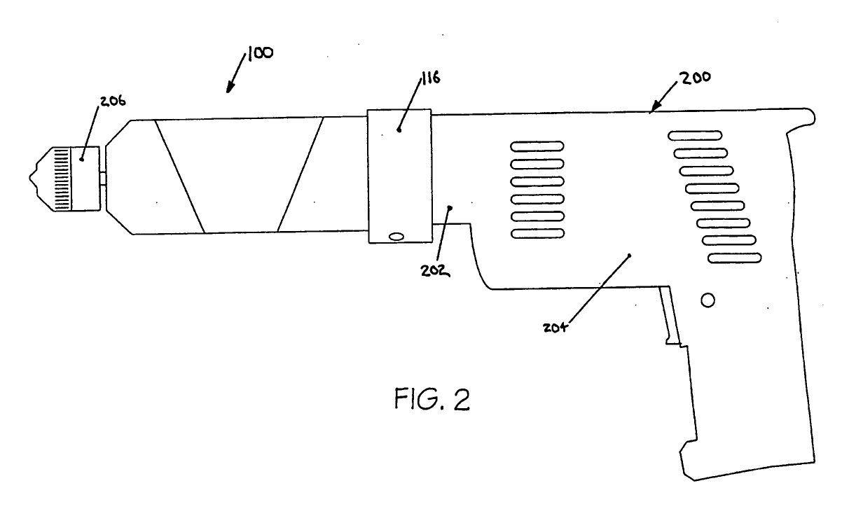

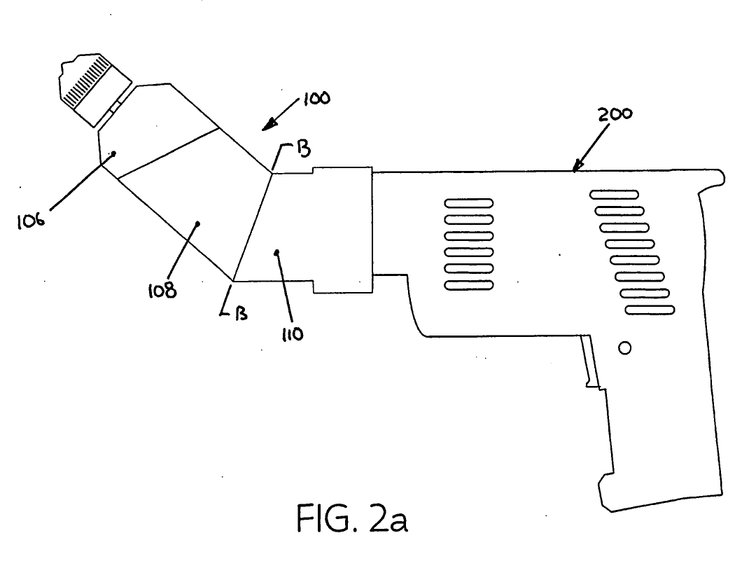

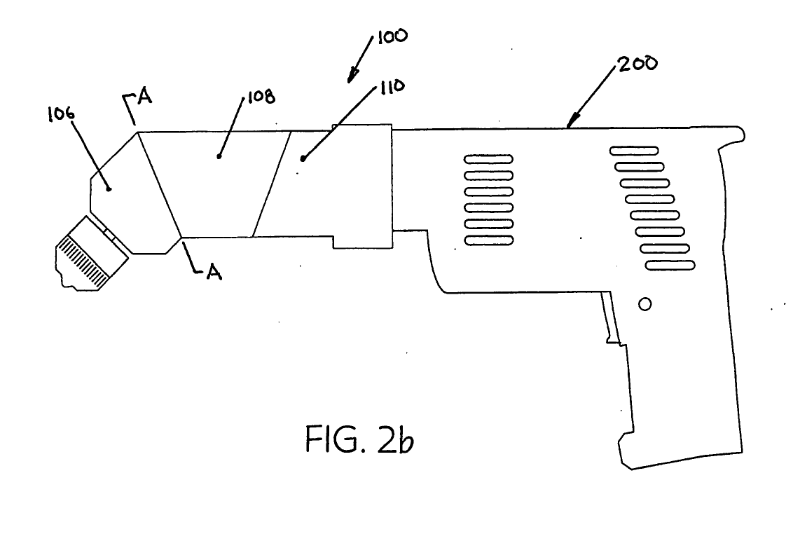

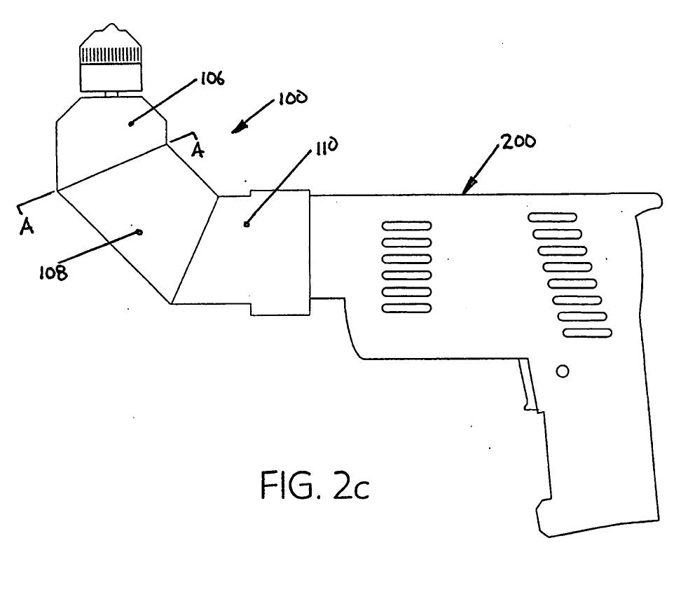

FIG. 2 shows a multidirectional transmission 100 according to an embodiment of the present invention mounted on a power drill 200. The transmission 100 is mounted on a generally cylindrical portion 202 of the drill casing 204 by means of its clamping collar 116. On the distal end of the driven shaft 130 is mounted the drill's chuck 206 which is adapted to receive drill bits in use.

In this Figure the housing elements 106, 108, 110 are aligned coaxially and the axis of rotation of the drive shaft and the driven shaft are aligned.

FIG. 2a shows the transmission of FIG. 2 in a different selected configuration. This configuration essentially corresponds to that of FIG. 1b, in that the housing has been rotated about plane B-B such that the driven shaft (drill chuck) will operate at an angle of about 45 degrees to the drive shaft (drill body) of the transmission 100.

FIG. 2b shows an alternative configuration for achieving a 45 degree offset between the drill chuck and drill body (i.e. the driven shaft of the transmission and the drive shaft of the transmission). In this configuration the offset has been achieved by rotating the front-most housing element 106 relative to the intermediate housing element 108 about plane A-A.

The configuration of FIG. 2c corresponds to that of FIG. 1c, and shows the drill chuck being set at an angle of 90 degrees to the drill body (i.e. the driven shaft of the transmission is set at an angle of 90 degrees to the drive shaft of the transmission). As described above this configuration is achieved by rotating housing element 106 90 degrees in plane A-A relative to housing element 108, and by rotating housing element 108 90 degrees in plane B-B relative to housing element 110.

As will be appreciated a wide range of angular offsets between the driven shaft and the drive shaft can be achieved by partially rotating the housing elements of the transmission. In the present embodiment the angles between 0 and 90 degrees are attainable. However by adding additional intermediate housing elements and transmission shafts greater angular offsets are possible.

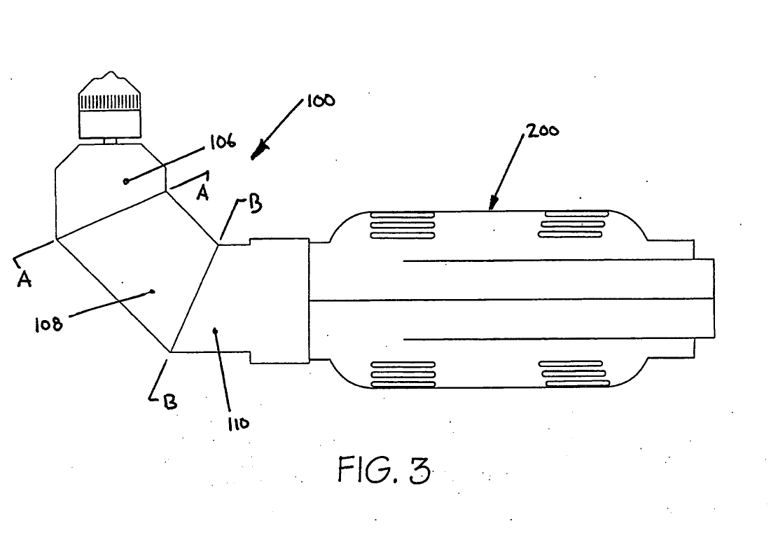

FIG. 3 shows the transmission in yet another angular configuration. As will be seen the drill chuck is set to operate at an angle of 90 degrees from the axis of the body, however rather than being offset in an “upward” direction as shown in FIG. 2c the drill chuck is offset to the right of the drill body by 90 degrees. This configuration is attained by arranging the transmission housing elements as shown in FIG. 2c and by also rotating the transmission assembly by 90 degrees relative to the body of the drill 200.

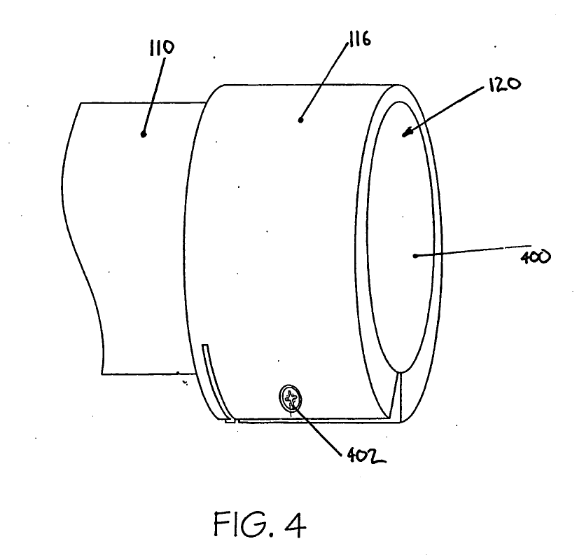

The clamping collar used on the preferred embodiment allows the angular orientation of the housing relative to the body of the drill to be selected in a straightforward manner. A close-up view of a preferred clamping collar that can be used to mount a transmission 100 to a hand-tool is shown in FIG. 4. The clamping collar arrangement 116 is formed integrally with the proximal housing element 110 and comprises a flange 400 extending from the housing element that forms a split cylindrical collar having an outer diameter larger than the main body of the housing element 110. The collar has a stepped bore 120 extending through it which is configured to receive and retain a bearing for holding the drive shaft 128 (not shown).

The clamping collar 116 is able to slide onto a receiving collar or flange on the body of a power tool and be tightened into place using screw 402. By tightening screw 402 the effective internal diameter of the bore 120 is reduced causing the clamping collar to be clamped onto the receiving collar or flange of the hand-tool.

In use a user can change the orientation of the transmission relative to the hand-tool on which it is mounted by loosening the screw 402, realigning the transmission into the new desired orientation and re-tightening the screw 402.

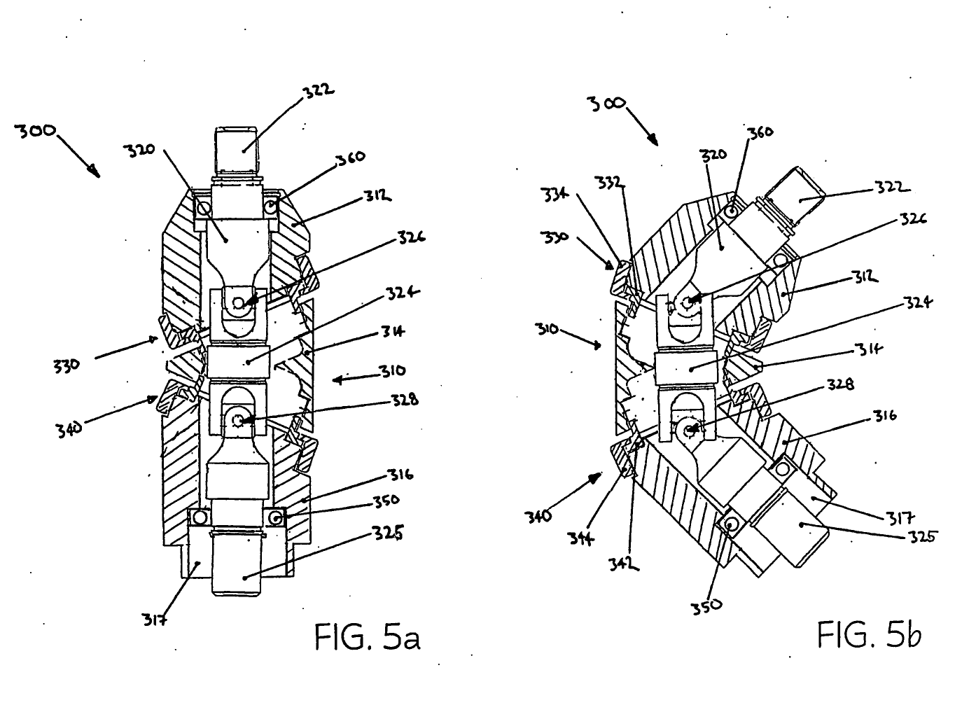

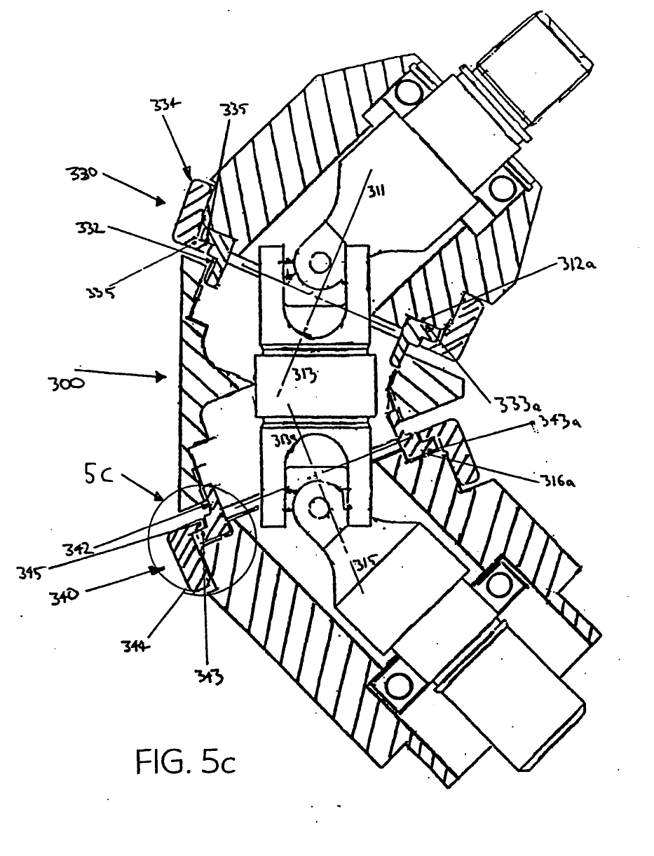

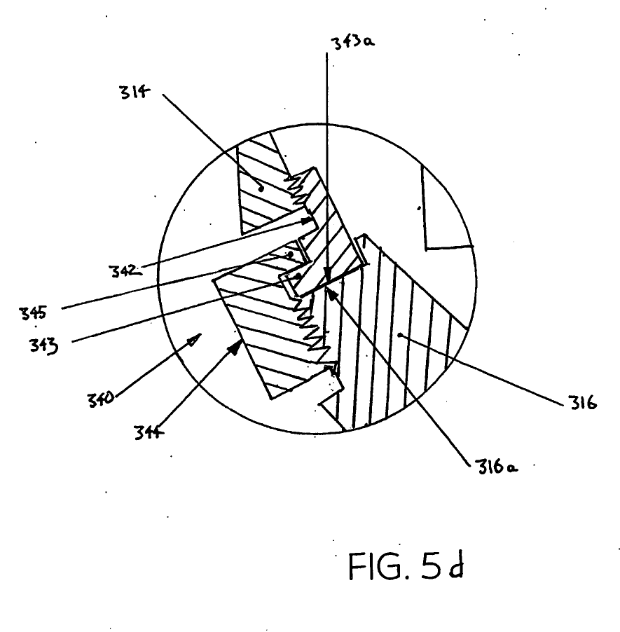

A second embodiment of a transmission 300 for a hand-tool in accordance with the present invention is shown in FIGS. 5a and 5. FIG. 5b depicts an axial sectional view of the transmission 300 when configured in an axial or linear arrangement similarly as depicted in FIG. 1a, and FIG. 5b depicts an axial sectional view of the transmission 300 when configured in a 90° configuration similarly as depicted and described with reference to FIG. 1c.

The present embodiment of the transmission 300 includes a housing 310 comprised of main housing elements, a distal housing element 312, an intermediate housing element 314 and a proximal housing element 316 coaxially arranged and each being essentially tubular so as to form a passage for the housing 310 and receiving the transmission assembly 320 of the transmission 300. The proximal housing element 316 includes a mounting recess 317 for engagement of the transmission 300 with a hand-tool, for example an electric drill similarly as described with reference to the first embodiment of the invention. The transmission 300 may be directly or indirectly engaged with a hand-tool via mounting recess 317, or alternatively, the transmission 300 as described may be formed integrally with a hand-tool.

In the present embodiment, the transmission assembly 320 comprises a driven shaft 322, an intermediate shaft 324, a first universal joint 326 and a second universal joint 328. The driven shaft 322 and the intermediate shaft are coupled via universal joint 326, universal joint 326 providing rotational coupling between the driven shaft 322 and the intermediate shaft 324 when the angle between the longitudinal axis of the driven shaft 322 is varied, similarly as described previously. Similarly, a second universal joint 328 couples the intermediate shaft 324 with a drive shaft 325. Although the drive shaft may, in other embodiments, be substantially shorter in length and in fact may provide for engagement with a further drive shaft, within the context of the present invention, any portion of transmission 320 proximal of the second universal joint 328 may be considered as being a drive shaft 325. This, to the skilled addressee, will be apparent of course, as a universal joint may be embodied in many structural variations and essentially, a joint providing the above discussed degrees of freedom is considered an embodiment of such joints. The actual universal joints 326 and 328 as depicted in the present embodiment, as with the previously described embodiment, include a pair of orthogonally oriented yokes. Again, it will be understood that any type of “universal joint” is considered to fall within the scope of the present invention as claimed and described.

Similarly as described with reference to the previous embodiment, the angle of inclination of the driven shaft 322 with respect to the drive shaft 325 may be varied by altering the angle of orientation of the longitudinal axes of one or more of the main housing elements 312, 314 and 316 with respect to an adjacent main housing element. The tubular passage of the housing elements 312, 314 and 316 may be elongate or elliptical in cross sectional shape to accommodate lateral movement of the driven shaft 322, the intermediate shaft 314, the drive shaft 316 or the universal joints 326 and 328. Each of the main housing elements 312, 314 and 316 again has an inclined plane and an associated normal axis to the planes 311, 313, 313a and 315 respectively as shown in FIG. 5c, an enlarged view of FIG. 5b. In the present embodiment the inclined planes are inclined at an angle of 45°, inclined with respect to its longitudinal axis of each housing element. As described with reference to the first embodiment, rotation of adjacent main housing elements about the normal axis to the housing element's inclined planes, thus causing the inclination of at least one of the shafts 322, 324 and 325 to be altered with respect to one of the other shafts. It should be noted that the arrangement or configuration of FIG. 5b causes axes 311, 313, 313a and 315 to be co-incidental.

It can be seen that the embodiment of the transmission 300 as depicted in FIG. 5a, when the intermediate housing element 314 is rotated 180° with respect to the distal housing element 312 and with respect to the proximal housing element 316, the first universal joint 326 and the second universal joint 328 allow an angle of 45° between the driven shaft 322 and the intermediate shaft 324 to be formed, and an angle of 45° between the drive shaft 326 and the intermediate shaft 324 to be formed, thus resulting in an angle of 90° being formed between the driven shaft 322 and the drive shaft 326. Those skilled in the art will appreciate that, as was described with reference to FIG. 1b, an angle of 45° may be formed between the driven shaft 322 and the drive shaft 326 rotating two adjacent housing members. Furthermore, other angles of inclination between the driven shaft 322 and the drive shaft 326 may be formed by varying the rotation of adjacent housing elements depending upon the angular requirement. It will be appreciated that configurations of the transmission as described with reference to FIGS. 2a-2c and FIG. 3 may be achieved with the transmission 300 of the present embodiment, and further configurations and orientations as required.

Although a small variation of angular velocity may occur between the input speed of the drive shaft 325 and the driven shaft 322, for typical applications that the present invention is applicable such as tightening and loosening of treaded items and for general drilling applications, such variations in angular velocity are negligible. In particular as typical powered hand-tools do not provide a constant angular velocity, but include geared systems which cause fluctuations in angular velocity of such tool's output shaft.

The housing 310 further comprises locking means 330 and 340 for releasably locking the angle of rotation of the distal housing element 312 in relation to the intermediate housing element 314 and the intermediate housing element 314 in relation to the proximal housing element 616, respectively. An enlarged spot sectional view of FIG. 5c is Shown in FIG. 5d. The locking means 330 and 340 comprise a retainer member 332, 342 having a passage and axis parallel to axes 313 and 313a respectively through which the transmission assembly 320 passes, and a locking nut 334, 344 also having a passage parallel to axes 313 and 313a through which the transmission assembly 320 passes, respectively. The retainer member 332, 342 includes a shoulder portion 333, 343 which abuts against a flange portion 335, 345 of the locking nut in a rotational sliding relationship such that the locking nut 334, 344 is rotatable about axes 313 and 313a respectively. The retainer member 332, 342 is engaged with the intermediate housing element 314 such that the locking nut 334, 344 is retained with the intermediate housing element 314. The retainer member 332, 342 may be engaged with the intermediate housing element 314 for example by threaded engagement, and optionally with the inclusion of an adhesive within the thread. Such engagement requires special mechanical means to be disengaged, and is not disengageable by hand or conventional tools by a user.

The locking nut 334, 344 engages with the proximal housing element 312 and the distal housing element 316 by complimentary threaded engagement means. Upon rotation of the locking nuts 334, 344 such that the locking nut 334, 344 move proximally and distally respectively, the locking nuts 334, 344 urges the proximal housing element 312 toward the intermediate housing element 314, and the distal housing element 316 toward the intermediate housing element 314, and abutment surface 333a, 343a engage with engagement surface 312a, 316a of the proximal and distal housing elements 312, 316 respectively such that the angle of the degree of rotation of the housing elements 312, 314 and 316 with respect to an adjacent housing element is fixed, hence securing the angle of the axis of the driven shaft 322 to the axis of the drive shaft 325.

The pitch of the thread of the locking nuts 334 and 344 is typically selected such that minimal turning is required so as to allow the housing elements 312, 314 and 316 to be rotated relative to an adjacent element, hence improving ease of reorientation of the driven shaft 322 with respect to the drive shaft 325. Stop means may be provided, for example, such that the locking nuts may only turn 180° so that excessive turning of the nuts 334, 344 is prevented. Furthermore, the housing elements 312, 314 and 316 may include a gradation or peripheral scale such that a user may be able to rotate the housing elements 312, 314 and 316 so as to achieve a predetermined angle of inclination of the shaft 322 with respect to the drive shaft 325.

Such that adjacent housing elements 312, 314 and 316 can not be removed from each other, during assembly after the locking nuts 334, 344 is at least partially engaged with the proximal housing element and the distal housing element respectively, the retainer member 332, 342 are then engaged with the intermediate housing element 314 similarly as described above and such that there is insufficient thread run out available, hence disassembly of adjacent housing elements 312, 314 and 316 is prevented.

In the present embodiment, bearings 350 and 360 are located within the proximal housing element 312 and the distal housing element 316 respectively and engaged with the driven shaft 322 and the drive shaft 325 hence allowing the drive assembly 320 to rotate within the housing 310. The bearings 350 and 360 may be secured within the proximal housing element 312 and the distal housing element 316 by means of a circlip or by other means such as interference fit or an adhesive. The drive assembly 320, by being retained within the housing 310 by bearings 350 and 360 such that it cannot be removed, in combination with the locking means as described above in the present embodiment, prevents the transmission 300 from being disassembled by a user. This tamper-proof mechanism as described provides a user with safety and prevents unauthorised or un qualified servicing of internal components.

The housing 310 and locking nuts 334, 344 of the transmission as described in accordance with the present embodiment may be formed from materials including aluminium alloys or alternatively suitable polymeric materials, depending upon the particular application of the transmission, for example.

It will be appreciated that the manner in which the housing 310 of the present invention is articulated is a preferred embodiment and that numerous alternate embodiments for providing such articulation are understood to fall within the scope of the invention.

It will also be appreciated that the geometrical configuration by which the above discussed articulation is provided, allows various angles of articulation to be obtained without the length between the end bearings, bearings 350 and 360 to alter significantly throughout articulation and as such, an axial lengthening or shortening element such as a splined arrangement is not required for the present embodiment. Small changes in length in the present embodiment throughout articulation and when in use may be accounted for in the tolerance of the end bearings 350 and 360, and/or the bearings of the universal joints 326 and 328. Of course, should a variation of articulation be embodied in an alternate arrangement of the present invention, an axial lengthening and shortening component, such as a splined shaft of a telescopic member may be required.

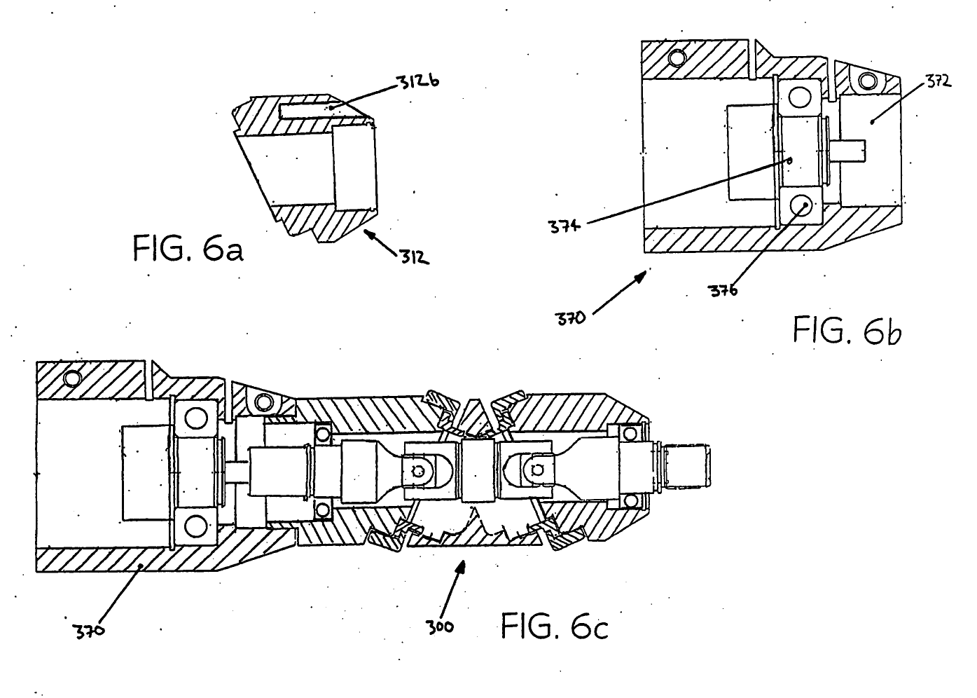

As depicted in FIG. 6a, the proximal housing element may optionally include provision for an illumination means in the form of a recess 312b to assist a user when using the transmission 300 in applications whereby ambient lighting is minimal. Suitable such illumination means include battery operated LED light source which may be located within the recess 312b. The proximal housing element may optionally further include a coolant delivery means for delivering coolant to a work area adjacent the transmission.

A clamping collar 370 suitable for securing the transmission 300 of the present embodiment similar to that as described with reference to that of FIG. 4 is shown in FIG. 6b. The clamping collar includes a recess 372 for receiving the proximal portion of the proximal housing element 316, a further drive shaft 374 for connecting the output drive of a hand-tool with the drive shaft 325 of the transmission 300. The further drive shaft 374 is rotatably mounted to the longitudinal axis of the clamping collar 370 via a bearing 376. It will be appreciated that the drive shaft 374 may be adapted to receive varies output shafts from various hand-tools accordingly.

As shown in FIG. 6c, the transmission as depicted in FIG. 5a is engaged with the clamping collar 370 of FIG. 6b in a similar manner as described with reference to FIG. 4. Alternatively, the transmission 300 and clamping collar 370 may be secured together by a locking means similar to that as described with reference to FIGS. 5a to 5d.

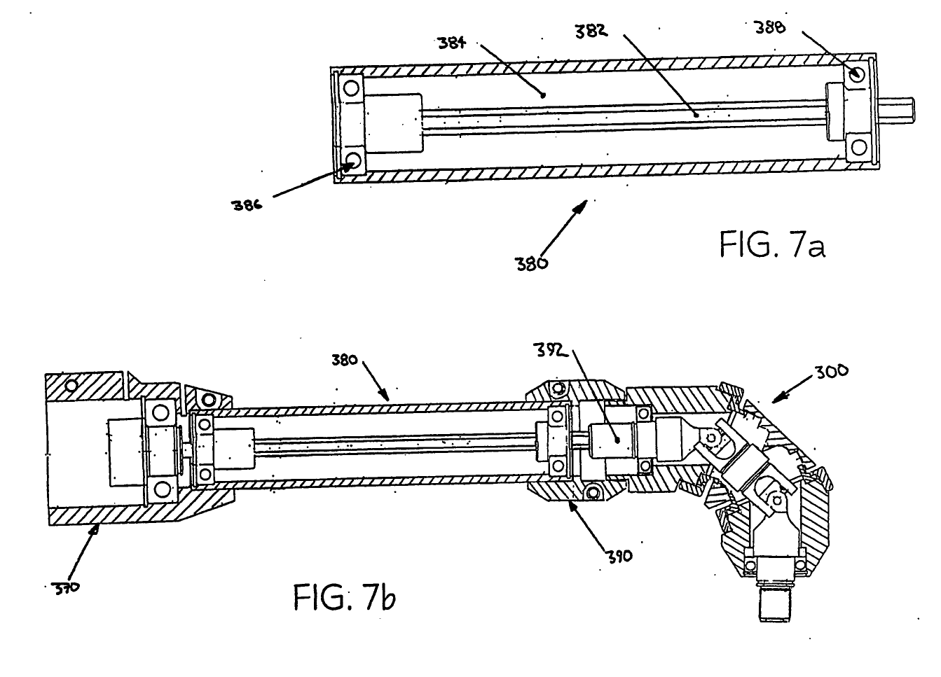

An extension member 380 suitable for use with the present embodiment is shown in FIG. 7a. The extension member 380 includes an extension shaft 382 rotatably mounted within extension chamber 384 by bearing 386 and 388 adjacent each end of the extension member 380. The extension member 380 is adapted to engage with a clamping collar 370 and an adapted member 390 as depicted in FIG. 7b. The adapter member 390 allows the extension member 380 to be rotatably engaged with a transmission 300 as described above in the present embodiment via yet a further drive shaft 392. The adapted member 390 may be engaged with the extension member 380 and the proximal housing element 316 of the transmission 300 in a similar clamping arrangement as described above with reference to FIG. 4, or alternatively by other locking means similar to that as described by a locking means as described with reference to FIGS. 5a to 5d. It will be appreciated that adaptations may be made to the present embodiment such that the extension member is mounted toward the proximal end of the transmission 300, depending upon the particular application to which the invention is directed.

It should be noted that the present inventor has found that using the transmission arrangement described does not become appreciably more prone to failure or fatigue as its length is increased, as opposed to cable drive transmissions. Cable drives, when bent or buckled whilst under cyclic loading, have significantly reduced service life or number of cycles to failure in comparison with a transmission as described with reference to the present invention. Furthermore, alternating cyclic loading significantly causes stress intensity factors at ends of the cable, again reducing the service life of such a drive. The present inventor has found significant increase in service life provided by the above described transmission to such an extent that the transmission assembly may be provided as a non-serviceable component, thus resulting in a more reliable and robust device.

A direct-drive transmission as claimed in the present invention, in the case of significant torque being applied through the drive train, is not prone to winding and preloading as is a cable drive transmission. Further, in applications such as tightening and loosening of treaded connections whereby significant torque is required turning a portion of the loosening and tightening cycle, a direct drive transmission does not suffer from the disadvantages of preloading and twisting as exhibited by a transmission of the cable type

Furthermore, a transmission of the type as claimed and described allows transmission of a length significantly greater than that of cable drive transmission. Transmissions of lengths of up to 0.5 metres may be constructed using the transmission of the present transmission. Cable type transmissions have been found to be limited to a length of about 15 cm to provide any degree of usefulness. Also, for loosening and tightening of threaded members, cable drives of any significant length twist to such an extent that the device is rendered inapplicable to such situations.

The present invention also proves a transmission that is not adversely affected during applications such as hammer drilling, as observed by the present inventor, which is not possible with transmissions incorporating flexible drive cables as the cable cannot transmit the impact force to the drill bit without deformation. Furthermore, the transmission may be provided with end bearings which, as well as providing angular rotation also allow a degree of axial translation, again enhancing the effectively of the present invention during hammer drilling.

The above described two embodiments have been described in connection with a transmission to be fitted to an existing drill body, either as original equipment, or as an aftermarket retrofitted attachment, however it should be noted that embodiments can be incorporated into a hand-tool as an integral component, e.g. as part of the housing of the tool. In such an embodiment the transmission body element housing the drive shaft can be integrally formed with the hand-tool's housing. Furthermore, the drive shaft of the hand-tool may in fact, when the transmission is fitted or included integrally with the hand-tool, form the drive shaft of the transmission as claimed.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A multidirectional transmission for a rotary hand-tool comprising:
a drive shaft having a first axis of rotation, said drive shaft being adapted to be detachably rotationally coupled to an output shaft of a rotary hand-tool;
a driven shaft having a second axis of rotation;
at least one intermediate shaft rotationally coupled between said drive shaft and said driven shaft via at least two universal joints; and
a housing adapted to receive said drive shaft, said at least one intermediate shaft and said driven shaft, said housing being adapted to allow the axis of rotation of the driven shaft to be adjustably inclined relative to the axis of rotation of the drive shaft and adjustably rotated thereabout the axis of rotation of the drive shaft.

2. A multidirectional transmission according to claim 1, wherein the housing is configured to be selectively angularly coupled to the rotary hand-tool about the axis of the output shaft of a rotary hand-tool.

3. A multidirectional transmission according to claim 2, wherein said housing is adapted to be coupled to the rotary hand-tool via a mounting attachment.

4. A multidirectional transmission according to claim 3, wherein said housing is rotationally engagable with the rotary hand tool via the mounting attachment about the axis of rotation of the output shaft of the rotary hand-tool.

5. A multidirectional transmission according to claim 4, wherein said housing is lockable at a predetermined angular position in relation to the axis of rotation of the output shaft of the rotary hand-tool.

6. A multidirectional transmission according to claim 1, wherein said housing includes an input end adapted to receive said drive shaft and an output end adapted to receive said driven shaft, and said housing is articulated to allow said axis of rotation of the drive shaft to be adjustably varied relative to the axis of rotation of the driven shaft.

7. A multidirectional transmission according to claim 6, wherein the drive shaft is journalled to the housing at the input end of the housing, and the driven shaft is journalled to the housing at the output end.

8. A multidirectional transmission according to claim 1, wherein said housing includes at least three substantially cylindrical housing elements arranged end to end, said housing elements having a passage formed therethrough lying substantially along a longitudinal axis of the housing and being adapted to receive the transmission shafts.

9. A multidirectional transmission according to claim 8, wherein the housing elements further include a seating surface lying in a plane inclined at oblique angle to the longitudinal axis of the housing element, wherein the relative orientation of adjacent housings elements is adjustable by rotation of the adjacent housing elements about the normal axis to said seating surface.

10. A multidirectional transmission according to claim 9, wherein said seating surface is adapted to abut a corresponding seating surface of an adjacent housing element.

11. A multidirectional transmission according to claim 9, wherein said driven shaft and said drive shaft are articulated with respect to the at least one intermediate shaft such that the pivot axes of said universal joints are located in the plane of said seating surface.

12. A multidirectional transmission according to claim 11, wherein the planes in which the seating surfaces of adjacent housing elements lie form a supplementary angle with each other such that in a first relative orientation the housing elements are coaxial with respect to the longitudinal axes of housing elements.

13. A multidirectional transmission according to claim 7, wherein the housing includes a lock adapted to fix one housing element relative to an adjacent housing element to allow the axis of rotation of said drive shaft to be fixed relative to the axis of rotation of said driven shaft at a selected orientation.

14. A multidirectional transmission according to claim 13, wherein said lock includes a locking nut threadingly engageable with a first housing element and rotationally slidingly engaged in relation to an adjacent housing element, wherein upon rotation of said locking nut, the first housing element and the adjacent housing elements are urged toward each other such that the housing elements are fixed relative to each other.

15. A multidirectional transmission according to claim 14, wherein said lock further includes a retainer member that retains said locking nut in relation to said adjacent housing element, said locking nut being rotationally slidingly engaged with said retainer member, wherein upon rotation of said locking nut said locking nut is advanced toward said first housing element, and said retainer member is urged toward and abutted with said first housing element by said locking nut such that the housing elements are fixed relative to each other.

16. A multidirectional transmission according to claim 15, wherein said locking nut is engaged with said first housing element and said retainer member, and said retainer member is non-detachably engaged with said adjacent housing element in a manner such that upon release of said locking means by rotation of said locking nut, the housing elements are detained in a coupled relationship.

17. A multidirectional transmission according to claim 1, further comprising at least one housing extension element detachably engageable with said housing, said housing extension element allowing use of an extended drive shaft and/or use of an extended driven shaft.

18. A multidirectional transmission according to claim 1, wherein said housing includes a light source that provides light to a work area adjacent the transmission.

19. A multidirectional transmission according to claim 1, wherein said housing includes a coolant delivery means for delivering coolant to a work area adjacent the transmission.

20. A multidirectional transmission according to claim 1, wherein said drive shaft, said driven shaft, said at least one universal joint and said housing are integrally formed.

21. A multidirectional transmission according to claim 1, wherein said driven shaft and said drive shaft are coupled with said housing to allow vibrational axial translation of said driven shaft and said drive shaft in relation to said housing.

22. A multidirectional transmission for a rotary hand-tool comprising:
a driven shaft having a first axis of rotation, said driven shaft being rotationally engageable with an output shaft of a rotary hand-tool having a second axis of rotation via at least one intermediate shaft located between the driven shaft and the output shaft of the hand-tool via at least two universal joints; and
a housing adapted to receive said drive shaft, said at least one intermediate shaft and the output shaft of the hand-tool, said housing being adapted to allow the axis of rotation of the driven shaft to be adjustably inclined relative to the axis of rotation of the output shaft of the hand-tool and adjustably rotated thereabout the axis of rotation of the output shaft of the hand-tool.

23. A rotary hand-tool having a multidirectional transmission including:
a driven shaft having a first axis of rotation, said driven shaft being rotationally engaged via at least one intermediate shaft via at least two universal joints with the drive shaft of the hand-tool having a second axis of rotation; and
a housing adapted to receive said drive shaft, said at least one intermediate shaft and said driven shaft, and being adapted to allow the axis of rotation of the driven shaft to be adjustably varied relative to the axis of rotation of the drive shaft said housing configured to be selectively angularly oriented relative to and about the drive shaft of the hand-tool.

24. A rotary hand-tool according to claim 23, wherein said driven shaft and said drive shaft are coupled with said housing to allow vibrational axial translation of said driven shaft and said drive shaft in relation to said housing.

25. A rotary hand-tool according to claim 23, wherein the hand-tool is driven by electrical, pneumatic, hydraulic or manual means, and is adapted to drive a rotationally driveable device including a screw, a bolt, a nut, a fastener, a stud or a drill bit.

26. A rotary hand-tool according to claim 23, wherein the rotary hand-tool includes a bi-directional drive device.

27. A rotary hand-tool according to claim 23, wherein the rotary hand-tool includes an axial vibrational drive.

28. A rotary hand-tool according to claim 23, wherein said transmission includes an engagement means for engagement with a tool bit.

29. A rotary hand-tool according to claim 23, wherein said housing is formed integrally with the rotary hand-tool.

30-31. (canceled)
